(19) United States
(12) Patent Application Publication
(10) Pub. No.: US 2016/0017983 A1
(43) Pub. Date: Jan. 21, 2016

(54) ROTARY GEAR SHIFTER

(71) Applicant: Dura Operating LLC, Auburn Hills, MI (US)

(72) Inventors: Steven P. Levesque, Rochester Hills, MI (US); Brian D. Howe, Shelby Township, MI (US)

(21) Appl. No.: 14/802,053

(22) Filed: Jul. 17, 2015

Related U.S. Application Data
(60) Provisional application No. 62/026,058, filed on Jul. 18, 2014.
(60) Provisional application No. 62/089,434, filed on Dec. 9, 2014.

(51) Int. Cl. F16H 59/02; F16H 59/08; F16H 61/24; F16H 59/04

(52) U.S. Cl. CPC F16H 59/0204; F16H 59/044; F16H 59/08; F16H 61/24; F16H 2059/0239; F16H 2059/081; F16H 2061/241

(57) ABSTRACT

In at least one embodiment a rotary shifter for a vehicle transmission includes a selector, a motor, a controller and a brake. The selector is adapted to be communicated with a vehicle transmission and rotated to multiple positions corresponding to different transmission gears. The motor is coupled to the selector to selectively alter the force required to rotate the selector among the multiple positions of the selector, and the controller is coupled to the motor and responsive to rotation of the selector to control actuation of the motor at least in part as a function of the rotary orientation of the selector. The brake is coupled to at least one of the selector or the motor to selectively inhibit or selectively prevent rotation of the selector.

### REFERENCE TO COPENDING APPLICATION

This application claims the benefit of U.S. Provisional Patent Application Ser. Nos. 62/026,058 filed Jul. 18, 2014 and 62/089,434 Dec. 9, 2014, which are incorporated herein by reference in their entireties.

### TECHNICAL FIELD

The present disclosure relates to a rotary gear shifter for shifting between transmission gears.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift level movement to a transmission shift mechanism. Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator.

### SUMMARY

In at least one embodiment a rotary shifter for a vehicle transmission includes a selector, a motor, a controller and a brake. The selector is adapted to be communicated with a vehicle transmission and rotated to multiple positions corresponding to different transmission gears. The motor is coupled to the selector to selectively alter the force required to rotate the selector among the multiple positions of the selector, and the controller is coupled to the motor and responsive to rotation of the selector to control actuation of the motor at least in part as a function of the rotary orientation of the selector. The brake is coupled to at least one of the selector or the motor to selectively inhibit or selectively prevent rotation of the selector.

In at least one implementation, the brake includes a magnetic field generator, a rotor coupled to the motor, and a brake member responsive to a magnetic field generated by the magnetic field generator to selectively engage the rotor and inhibit or prevent rotation of the rotor and motor. The magnetic field generator may include an electrical coil. In at least some implementations, the brake member engages the rotor when electrical power is not supplied to the magnetic field generator and the brake member is released from the rotor when electrical power is supplied to the magnetic field generator.

In at least some implementations, the controller may be responsive to attempted rotation of the selector when the brake member is engaged with the rotor, and the controller determines whether to release the brake member from the rotor or to maintain the brake member engaged with the controller based on at least one of the position of the selector or a condition relating to vehicle operation at the time of the attempted rotation of the selector.

In at least some implementations, the brake includes a first rotor portion coupled to the motor for rotation with the motor and a second rotor portion selectively engaged by the first rotor portion to permit limited relative rotation between the first rotor portion and the second rotor portion. Biasing members may yieldably bias the first rotor portion relative to the second rotor portion.

In at least some implementations, a rotary shifter includes a transmission gear selector and a secondary selector. The transmission gear selector may be adapted to be communicated with a vehicle transmission and rotated to multiple positions to shift among transmission gears, and have a body and a recess defined by the body. The secondary selector may be received at least partially within the recess and arranged so that the secondary selector may be actuated separately from the transmission gear selector. In at least some implementations, the transmission gear selector is rotatable relative to the secondary selector.

In at least some implementations, the secondary selector includes a button that may be pushed independently of the rotation of the transmission gear selector to actuate a switch.

In at least some implementations, a lost motion coupling within the transmission gear selector permits relative movement between two components. The relative movement between the two components may occur at the beginning of a gear selection.

In at least some implementations, the transmission gear selector includes a rotatable knob adapted to be communicated with a vehicle transmission and rotated to multiple positions to command transmission gear shifts, and the secondary selector is carried by the knob and arranged so that the secondary selector may be actuated separately from the rotation of the knob and wherein the knob is rotatable relative to the secondary selector, and which also includes:

a motor coupled to the knob to selectively rotate the knob or to selectively alter the force required to rotate the knob among the multiple positions of the knob; and

a controller coupled to the motor and responsive to rotation of the knob to control actuation of the motor at least in part as a function of the rotary orientation of the knob.

In at least some implementations, a main housing is included and the secondary selector is connected to the main housing so that the secondary selector does not rotate with the knob.

In at least some implementations, a rotary shifter includes a shift selector, a stepper motor, a controller and an optical sensor. The shift selector is rotatable and adapted to be communicated with a vehicle transmission and rotated to multiple positions to command transmission gear shifts. The stepper motor is coupled to the shift selector to selectively provide a force that affects rotation of the shift selector, and the controller is coupled to the stepper motor and responsive to rotation of the shift selector to control actuation of the stepper motor at least in part as a function of the rotary orientation of the shift selector. The optical sensor is associated with the shift selector to determine a rotary position of the shift selector or components associated with the shift selector.

In at least some implementations, the optical sensor includes an optical encoder.

In at least some implementations, the shift selector has at least one detent valley feel indicative of a drive condition of a motor vehicle, and the stepper motor resists movement of the shift selector in a position past the detent valley feel, assists movement of the shift selector prior to the detent valley feel, and provides a force tending to hold the position of the shift selector at the detent feel. And a controller may be coupled to the stepper motor assembly which may have a coil that is powered in response to a signal from the controller, where the power changes depending on the position of the shift selector.

In at least some implementations, an optical movement sensor assembly is electrically coupled to the controller and has a signal indicative of movement of the shift selector.

Other embodiments can be derived from combinations of the above and those from the embodiments shown in the drawings and the descriptions that follow. Further, within the scope of this application it is envisaged that the various aspects, embodiments, examples, features and alternatives set forth in the preceding paragraphs, in the claims and/or in the following description and drawings may be taken independently or in any combination thereof. For example, features disclosed in connection with one embodiment are applicable to all embodiments, except where there is incompatibility of features.

### BRIEF DESCRIPTION OF THE DRAWINGS

The following detailed description of preferred implementations and best mode will be set forth with regard to the accompanying drawings, in which:

FIG. 1 is a perspective view of a rotary gear shifter;

FIG. 2 is a plan view of the gear shifter;

FIG. 3 is a side view of the gear shifter;

FIG. 4 is a cross-sectional view of the gear shifter;

FIG. 5 is an exploded view of the gear shifter;

FIG. 6 is a cross-sectional view of a gear shifter;

FIG. 7 is another cross-sectional view of the gear shifter of FIG. 6;

FIG. 8 is an exploded view of a gear shifter;

FIG. 9 is a cross-sectional view of the gear shifter of FIG. 8;

FIG. 10 is a perspective view of certain components in the gear shifter; and

FIG. 11 is a perspective view of a portion of a brake assembly in the gear shifter.

### DETAILED DESCRIPTION OF PREFERRED EMBODIMENTS

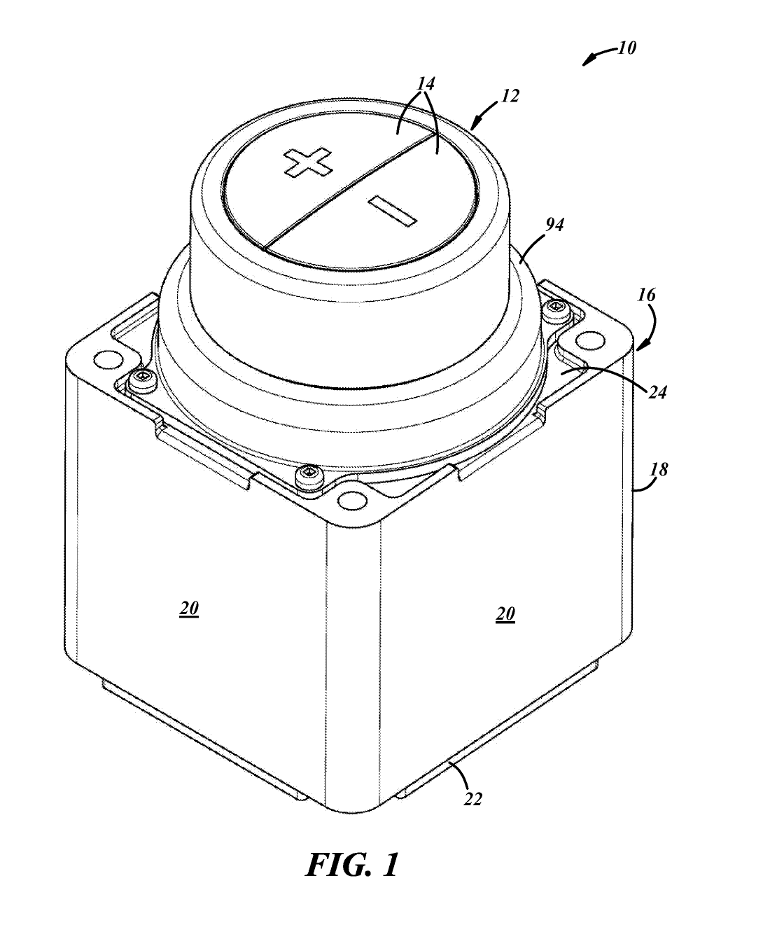

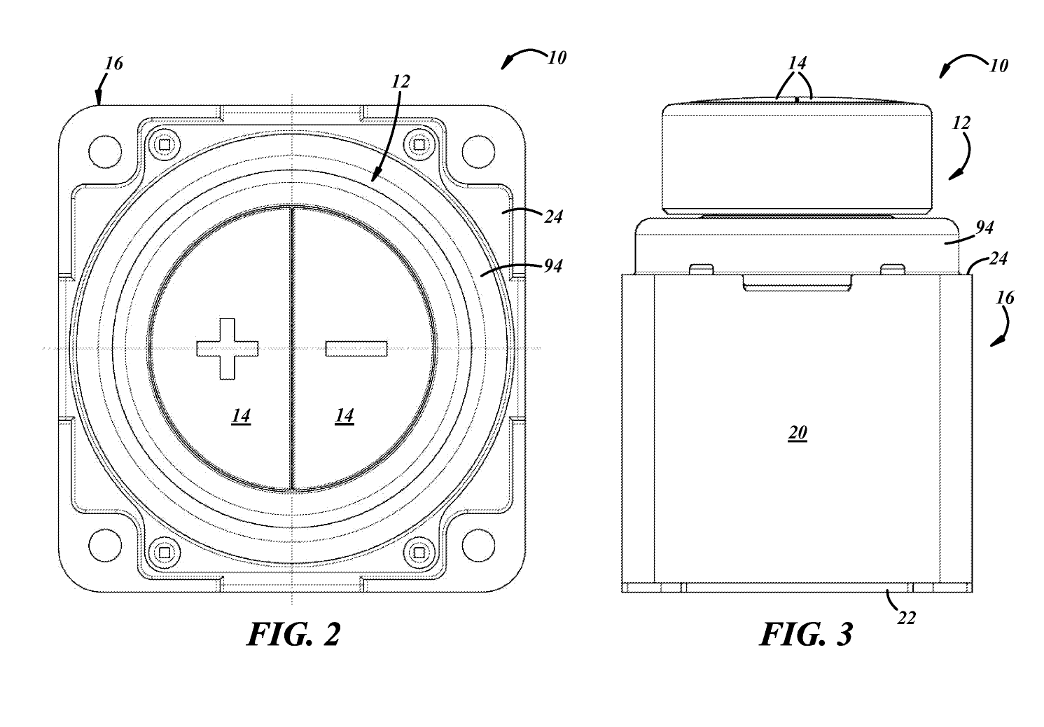

Referring in more detail to the drawings, FIGS. 1-5 illustrate a rotary gear shifter 10 which may be used to shift among various gears of a transmission. In at least some implementations, the shifter 10 is not directly mechanically coupled to the transmission and instead communicates electrically with an actuator that, in turn, causes a change in the selected transmission gear in a so-called shift-by-wire system. The shifter 10 may include a rotary selector, such as a dial or knob 12, that may be manually rotated by a user through multiple positions corresponding to multiple gears of the vehicle transmission. In addition, in at least some implementations, the shifter 10 also includes one or more secondary selectors 14, such as buttons or switches, that may be manipulated independently of the rotary knob 12, providing further control options for the user. By way of non-limiting examples, the knob 12 may include and be rotated to one or more positions that correspond to park, reverse, neutral and drive gears for a vehicle transmission. The buttons 14 may be used to provide discrete upshifts or downshifts between forward drive gears in the transmission (e.g. manual shifting in a “sport” or “manual” mode), or for some other reason related to transmission shifter or perhaps related to another vehicle system, such as an entertainment or infotainment system. In that regard, the knob 12 and buttons 14 and all of what has been called shifter 10 may be used in a system other than for shifting transmission gears and may comprise a Human-Machine Interface (HMI) device that may be used in a wide range of systems. Further, the HMI device is readily programmable to provide a wide range of operating functions, user feedback and controls.

The shifter 10 may include a main housing 16 having a body 18 to which the rotary knob 12 is mounted. The body 18 may be of any desired shape and is shown as having four rectilinear sidewalls 20, a bottom wall 22 and an upper wall or surface 24 adjacent to the knob 12 and defining a substantially complete enclosure and a modular shifter that may be easily assembled into a vehicle. The housing 16 may be formed from any suitable material, and the bottom wall 22 may be integrally formed with the sidewalls 20 or connected thereto such as by one or more fasteners.

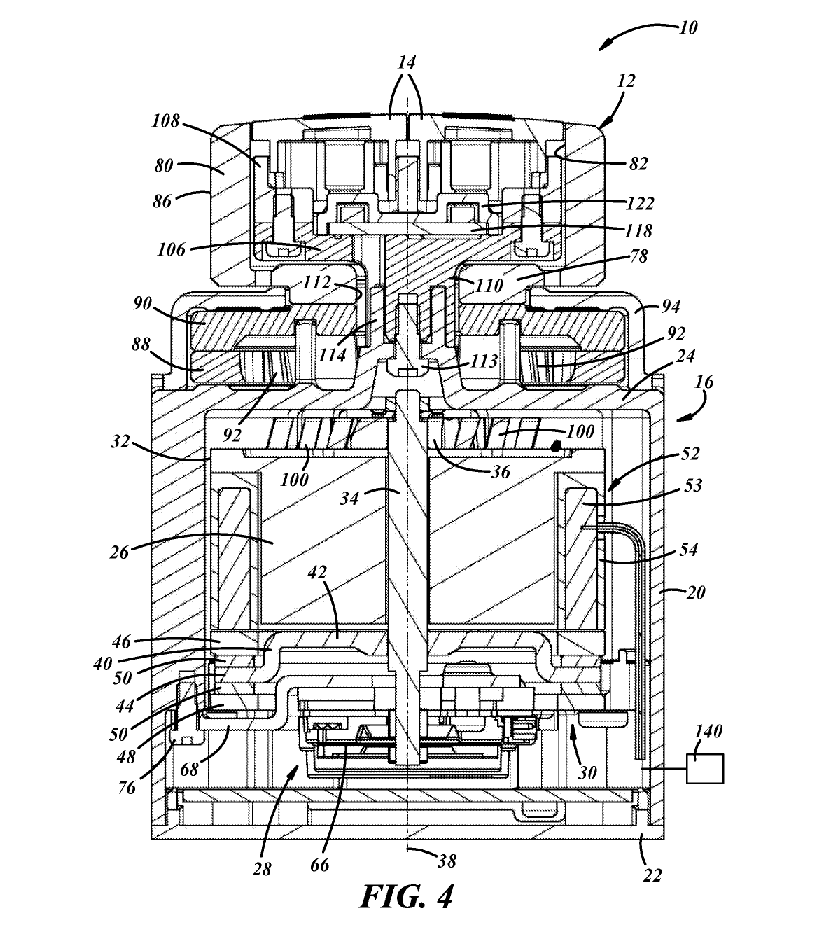

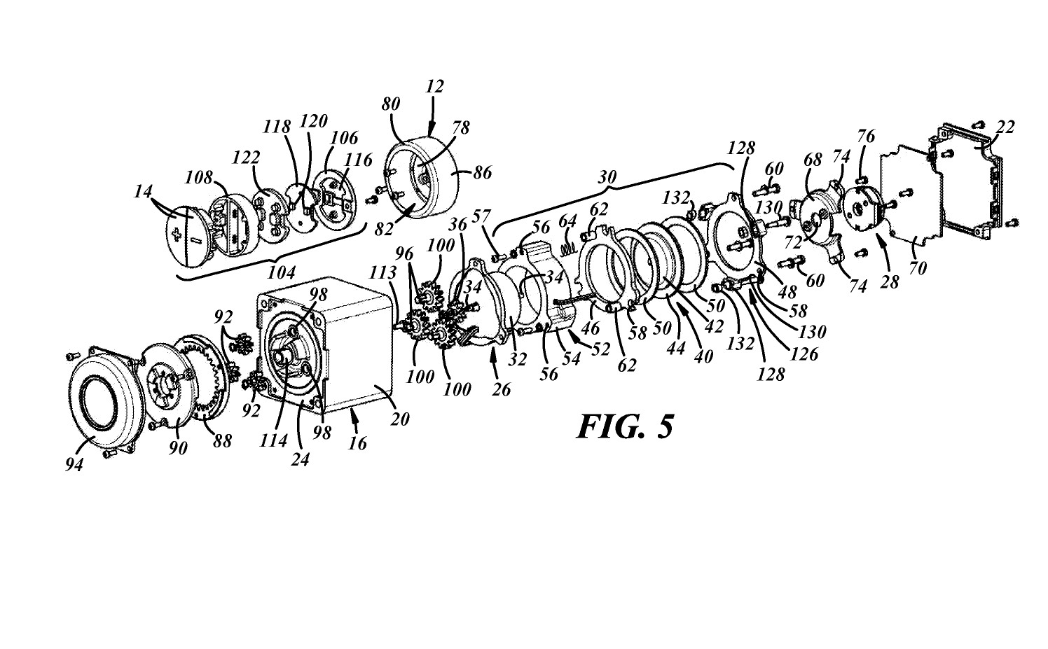

Within the housing 16, as shown in FIGS. 4 and 5, the shifter 10 may include a motor 26, a position sensor 28 and a brake 30 or locking mechanism. The motor 26 may be any device suitable to control, at least in part, rotation of the knob 12 and in at least some implementations is a stepper motor which may allow more precise rotation, force application and position determination. The motor 26 may be electrically operated and have a body or casing 32 and a pin 34 driven for rotation upon application of electrical power to the motor 26. The pin 34 may extend outwardly from the motor casing 32 and be coupled to the brake 30, the position sensor 28 and one or more gears. In the implementation shown, the brake 30 and position sensor 28 are coupled to the motor pin 34 at one end and a gear 36 is coupled to an opposite end of the motor pin 34, extending from an opposite side of the casing 32. The gear 36, in turn, is coupled to the knob 12 such that rotation of the knob 12 causes rotation of the gear 36 and rotation of the motor pin 34, as will be described in more detail below. The motor 26 may be selected to provide a desired force output to the gear 36, a desired response profile, a desired current draw, a desired size or for all, none or any combination of these properties. In the implementation shown, the motor casing 32 is generally cylindrical and the motor pin 34 is coaxial with the motor 26 and driven for rotation about that axis 38.

The brake 30 may be any device or component able to selectively inhibit or prevent rotation of the motor 26 and/or knob 12. In this regard, the brake 30 may positively lock and prevent rotation of the motor 26, or it may inhibit or prevent rotation up to a force threshold. In one implementation, the brake 30 includes a rotor 40 coupled to the motor pin 34 for co-rotation with the motor pin and a clamp or other component moveable relative to the rotor 40 to selectively engage and inhibit or prevent rotation of the rotor 40 which, in turn, inhibits or prevents rotation of the motor pin 34. In the implementation shown, the rotor 40 is a thin plate or disc keyed to the motor pin 34 and having a central portion 42 that is axially offset or raised, in the example shown, to accommodate adjacent components, and has a peripheral rim 44. Because the rotor 40 is keyed for co-rotation to the motor pin 34, inhibiting or preventing rotation of the rotor 40 will inhibit or prevent rotation of the motor pin 34. The clamp, in the implementation shown, includes a first clamp plate 46 located on one side of the rotor 40 and a second clamp plate 48 located on the opposite side of the rotor 40. The clamp plates 46, 48 may be annular, generally flat and arranged to engage the rim 44 of the rotor 40. If desired, brake pads 50 may be provided between the clamp plates 46, 48 and the rotor 40 to improve the frictional braking therebetween. If desired, the clamp plates 46, 48 and rotor 40 may be formed of metal and the brake pads 50 may be formed from metal or a different material. The brake pads 50 may overlie any desired portion of the rim 44 to provide a desired braking force onto the rotor 40, when the brake 30 is actuated. No structure or material property is intended to be required in the brake pads 50 and the term “pad” is used merely for convenience in describing the non-limiting implementation shown in the drawings.

The brake 30 may further include an actuator 52 that changes the state or position of at least one clamp plate 46, 48 to either actuate or release the brake 30. In at least some implementations, the brake actuator 52 includes a magnetic field generator, such as a wire coil 53 that generates a magnetic field upon application of electrical power to the coil 53. The coil 53 may be carried in a housing 54, and for compactness, the coil 53 and coil housing 54 may surround and axially overlap at least a portion of the motor casing 32. The coil housing 54 may include openings 56 and fastener 57 may couple the motor 26 to the housing. Openings 56 may also be aligned with openings 58 in the clamp plates 46, 48 for receipt of fasteners 60 holding the brake clamp plates 46, 48 and pads 50 in place and adjacent to the rotor 40 and coil housing 54. At least one of the clamp plates 46, 48 is movable relative to the coil housing 54 to selectively apply a braking force to the rotor 40. In the implementation shown, the first clamp plate 46 is movable relative to the coil housing 54 and spacers 62 (FIG. 5) may be provided around the fasteners 60 and between the coil housing 54 and second clamp plate 48 to prevent movement of the second clamp plate 48 and ensure a desired spacing between these components.

To actuate the brake 30, one or more biasing members 64 (FIG. 5) may be provided to move the first clamp plate 46 toward the second clamp plate 48 and thereby clamp the rotor 40 between the clamp plates 46, 48 (and any brake pads 50 provided between them). The biasing members 64 may include one or more springs located between the coil housing 54 and the first clamp plate 46. The force that the springs 64 provide on the first clamp plate 46 may be chosen to prevent rotation of the rotor 40 until a threshold force is applied to the rotor 40 through the knob 12, or otherwise as desired.

To release the brake 30, electrical power is provided to the coil 53 and a magnetic field is generated by the coil 53. The magnetic field draws the first clamp plate 46, which may be formed from an electromagnetically responsive material, toward the coil housing 54 and away from the rotor 40 which releases or sufficiently reduces the force provided on the rotor 40 to permit the rotor 40 to rotate relative to the clamp plates 46, 48 and any brake pads 50. In this way, power is provided to the coil 53 only when it is desired to permit a user to turn the knob 12. An alternate arrangement may be used wherein power to the coil 53 is provided to cause the clamp plates 46, 48 to engage the rotor 40 and provide the braking force, and the springs 64 are used to release the brake 30 when electrical power is not provided to the coil 53. But this arrangement may result in greater power consumption as the time when the knob 12 is not rotated is likely to be greater than the time in which the knob 12 is actually rotated.

The position sensor 28 may be any component capable of determining at least certain positions of the motor 26. In the implementation shown, the position sensor includes an optical encoder 28 and associated circuitry. The encoder 28 includes or is responsive to at least one component that rotates with the motor pin 34. In the implementation shown, the encoder 28 includes a wheel 66 (FIG. 4) that is coupled to the motor pin 34 for rotation with the motor pin 34. The wheel 66 may include markings, notches or the like that are detected by the encoder electronics as the wheel 66 rotates with the motor 26. In this way, the encoder 28 can determine the rotary position of the wheel 66 at any given time, within resolution limits of the encoder 28 being used. The brake 30 may be provided between the encoder 28 and the motor 26. The encoder 28 may be coupled to a mounting plate 68 and include a circuit board 70 received between the encoder 28 and the bottom wall 22 of the shifter main housing 16. The mounting plate 68 may include a central opening 72 through which the motor pin 34 extends and one or more mounting holes 74 through which fasteners 76 extend to couple the mounting plate 68 to the main housing 16. Of course, other arrangements are possible and may be used, and sensors other than an optical encoder may be used (for example, without limitations, a variable resistance card and contacting wiper, etc). In at least some implementations, the rotation sensed by the encoder 28 is initiated by user rotation of the knob 12 which is done to shift the transmission.

The knob 12 is coupled to the motor 26 and the motor may assist or inhibit rotation of the knob 12 to control the movement and feel of the knob rotation as the transmission is shifted. In the implementation shown, the knob 12 is coupled to the motor 26 by one or more gears which permits further control of the knob rotation, such as by reducing or increasing the torque and/or reducing or increasing the rotary output for a given amount of rotation of the knob 12. In at least some implementations, to accommodate internal buttons or for other reasons, the knob 12 includes a radial surface 78 and a sidewall 80 that defines a recess 82 in which one or more secondary selectors, such as the buttons 14 or other electrical actuators, switches or the like, are received. The sidewall 80 may extend axially from the radial surface 78 which extends inwardly from the sidewall 80. The sidewall 80 may be cylindrical and circumferentially continuous, or have any desired shape. An outer surface 86 of the sidewall 80 may be grasped by a user to rotate the knob 12 relative to the main housing 16 and effect a transmission gear change as will be described in more detail later. The radial surface 78 may define a bottom of the recess 82 and be mounted to a first gear 88 either directly or via a gear plate 90 disposed between the knob 12 and first gear 88. Of course, the knob 12 could be connected to the gear or gear plate in any other desired manner.

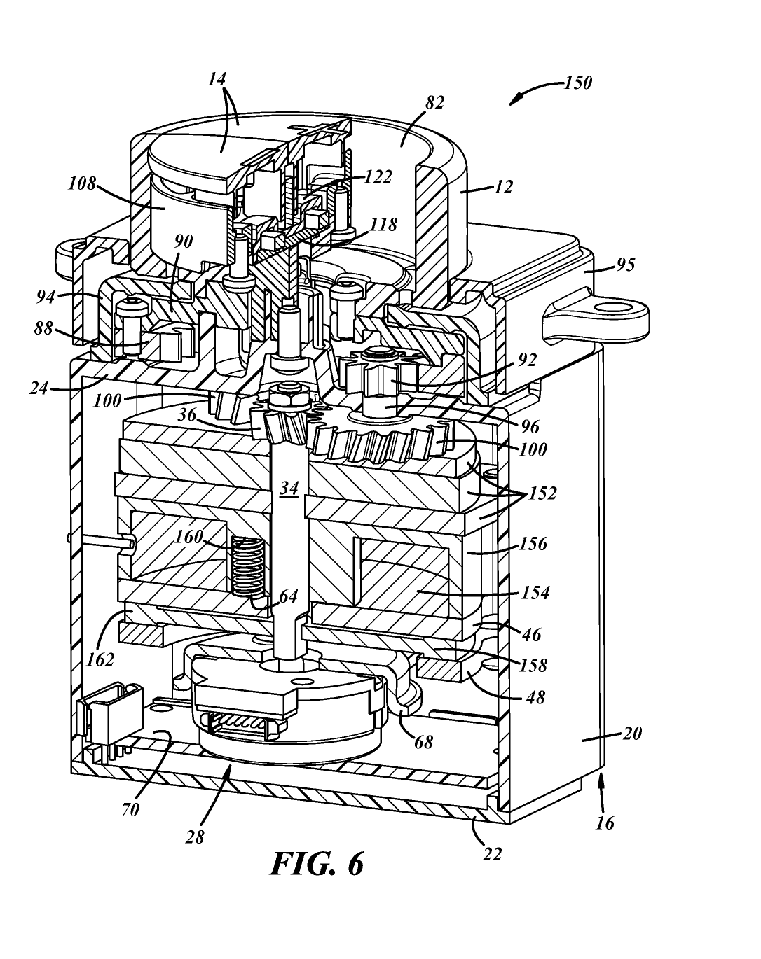

In the implementation shown, the first gear 88 is part of a gear train that includes multiple gears, in one or more sets, between the knob 12 and motor 26. The first gear 88 is mated with one or more secondary gears 92 (three are used in the implantation shown) and together these gears may define a first gear set. The first gear set may be located outside of the main housing 16 and may be received within a cover 94 connected to the main housing 16 that may be decorative and/or function to keep contaminants out of the gear train and housing 16 (and possibly at least partially covered by a decorative or protective bezel 95 as shown in FIG. 6). The first gear set is coupled to a second gear set that may be located within the main housing 16 to transmit the rotary motion of the knob 12 to the interior of the main housing 16. In the example shown, the first gear 88 is a ring gear coupled directly to the knob 12 and having internal teeth and the secondary gears 92 include multiple spur gears with external teeth that are mated with the ring gear teeth. The number of teeth among the gears 88, 92 may be controlled to provide a desired increase or decrease of rotary motion and torque between the knob 12 and motor 26. In the example shown, the first gear 88 includes 36 teeth and the secondary gears 92 include 9 teeth providing a 4:1 ratio. This means that the secondary gears 92 rotate 4 times for each rotation of the first gear 88. Of course, any desired gear ratio may be used.

The secondary gears 92 of the first gear set are mounted to axles 96 that extend through openings 98 in the main housing 16. Each axle 96 may be coupled to a separate gear 100 of the second gear set. The second gear set may also include the motor gear 36 that is fixed to the motor pin 34 for co-rotation with the motor pin 34. The motor gear 36 is located between and has teeth meshed with external teeth of the other gears 100 in the second gear set. Here again, the gears 100 and motor gear 36 may provide any desired gear ratio within the second gear set. In the example shown, the gears 100 have 18 teeth and the motor gear 36 has 9 teeth providing a 2:1 ratio. This means that the motor 26 gear rotates 2 times for each rotation of the other gears 100 in the second gear set. Together, the first and second gear sets, in the non-limiting example shown in the drawings, provide a gear ratio of 8:1. This means that the motor pin 34 rotates 8 times for each rotation of the knob 12.

The motor 26 may be actuated to assist or inhibit rotation of the knob 12. One reason this may be done is to provide a desired feel or sensory feedback to a user as the user rotates the knob 12. In one example, the motor 26 resists rotation of the knob 12 a desired amount for a first portion of the knob rotation from a first position to a second position (e.g. the first portion of rotation from PARK to REVERSE) and then provides less resistance, no resistance or even some assistance to continued rotation of the knob 12 during a second portion of the knob rotation toward the second position. This may give the user the feeling that the knob 12 has been rotated over a detent or other mechanical feature between and serving to separate and define the first and second positions. The amount of force the motor 26 provides at any given rotational position of the knob 12 between the first and second positions may be electronically controlled and programmed as desired. In one example, the force steadily increases to a peak force midway between the first and second positions and then decreases from the peak force until the second position is reached. Thereafter, continued rotation to a third position is again resisted with an increasing force. This provides the user with a more definite feeling that the second position has been accurately selected (compared to simply relying on a visual indication that the knob position was changed) and reduces the likelihood that the user will overshoot the second position and instead put the knob 12 in its third or another position.

During the second portion of the knob rotation, the motor 26 may provide a force that assists the knob rotation, if desired. This may ensure that the knob 12 is not left between two positions even if the user stops rotating the knob 12 (e.g. releases the knob) and will provide such feedback to the user through the knob 12 if the user still is holding the knob 12. Likewise, if the user releases the knob 12 before a given point in the rotation between two positions, the motor 26 may rotate the knob 12 back to the initial of the two positions as a threshold amount of knob rotation was not achieved by the user to cause a gear change. Of course, other force feedback may be provided to the user as desired and this may include force from the motor, the brake, or both.

In an electronic shifter, the motor interaction with the knob may provide a detent valley feel to a user manipulating the knob. The detent valley feel may be indicative of a drive condition of a motor vehicle, for example that the vehicle is shifted into one or more gears of vehicle operation. The stepper motor assembly coupled to the shift selector may resist movement of the shift selector in a position past the detent valley feel, assist movement of the shift selector prior to the detent valley feel, and hold the position of the shift selector at the detent valley feel. In at least some implementations, the detent valley feel is defined by an increased resistance to rotation of the shift selector in either direction away from a selected position.

In at least some forms, the electronic shifter may include a controller coupled to the stepper motor assembly and the stepper motor assembly may include a coil that is powered in response to a signal from the controller. The power provided to the coil may be changed depending on the position of the shift selector, and this may be programmable and adjustable as desired. The electronic shifter may further include an optical movement sensor assembly electrically coupled to the controller. The optical movement sensor assembly may have or provide a signal indicative of movement of the shift selector.

In at least some implementations, non-rotating buttons 14 are carried by the knob 12. The buttons 14 may be carried by a button housing 104 received within the knob recess 82 and fixed to the shifter main housing 16 such that the button housing 104 and buttons 14 do not rotate with the knob 12. The button housing 104 may include a base 106 and a button guide 108. The base 106 may include an axially extending stem 110 received through an opening 112 in the radial surface 78 and fixed, such as by a fastener 113, to the main housing 16 (e.g. to an upstanding boss 114 on the housing 16). The base 106 may further include a mounting surface 116 that may extend radially within the knob recess 82 and provide a surface to which associated electronics may be mounted. In the implementation shown, the buttons 14 may be pushed or depressed relative to the knob 12 to engage switches on a circuit board 118. LED's 120 may be provided to illuminate the buttons 14 or indicia on the buttons, as desired, and a cover 122 may be provided to prevent direct contact between the buttons 14 and circuit board 118, if desired. The button guide 108 may be provided between the knob sidewall 80 and the buttons 14, extending generally axially relative to the base 106 and within the recess 82. The buttons 14 are seated on and are actuated/moved relative to the button guide 108 to actuate switches on the circuit board 118. In one example, two buttons 14 are provided. One button 14 may be used to manually upshift the transmission and the other may be used to manually downshift the transmission, as is common in certain manual or “sport” driving modes to give the user some control over the transmission shift points between various forward drive gears. Of course, the buttons 14 (as well as all of the shifter 10) could be used for a purpose other than shifting, and unrelated to the transmission such as for an infotainment system, vehicle lighting, temperature control, etc.

To inhibit or prevent accidental, unintentional or undesired rotation of the knob 12, the brake 30 may be applied. As noted above, the brake 30 may be applied at all times when electrical power is not supplied to the brake coil 53. This presents challenges with regard to detecting when a user initiated shift is occurring, and in preventing unintended or undesired shifting of the vehicle. In at least some implementations, the coil housing 54 and second clamp plate 48 are connected together (e.g. by fasteners) and are effectively unitary, in other words, they behave as a single, rigid component. When the brake 30 is applied, the rotor 40 and hence the motor 26 and its pin 34 are also effectively coupled to the second clamp plate 48. In addition to being coupled to the coil housing 54, the second clamp plate 48 may also be connected to the shifter main housing 16 by way of a lost motion coupling 126 (FIG. 5). The lost motion coupling 126 may take any desired form and permits at least a limited rotation of the knob without causing a transmission shift. In at least some implementations, the lost motion coupling permits limited rotation of a portion of the shifter 10, e.g. the knob and some associated components, that may be sensed by the encoder, while the brake 30 is applied or rotation of the knob or a transmission shift is otherwise prevented.

In the implementation shown, the lost motion coupling permits at least a limited movement (e.g. rotation) of the second clamp plate 48 and/or the coil housing 54 relative to the main housing 16. Because the encoder 28 is fixed to the main housing 16 and does not rotate with the motor 26, the limited movement of the second clamp plate 48 relative to the main housing 16 may be sensed or determined by the encoder 28 as the motor 26, motor pin 34 and rotor 40 would be moved relative to the main housing 16 and the encoder 28 when torque is applied to the knob 12. Of course, other arrangements may be used.

In the implementation shown, the lost motion coupling 126 includes slots 128 formed in the second clamp plate 48, and fasteners 130 that extend through the slots 128 (e.g. one fastener per slot) and are fixed to the main housing 16. Accordingly, torque applied to the knob 12 when the brake 30 is applied will result in some movement of the second clamp plate 48 relative to the fasteners 128 (due to the clearance between them that is provided by the slots 128) and hence, relative to the main housing 16. One or more biasing members 132 may be provided to yieldably bias the second clamp plate 48 relative to the main housing 16. When torque is no longer applied to the knob 12, the biasing members 132 may return the second clamp plate 48 to a home position, wherein the fasteners 128 are spaced from each end of the slots 130 in the second clamp plate 48. This permits movement of the second clamp plate 48 relative to the main housing 16 in either rotary direction, as torque may be applied to the knob 12 in both directions in use and both directions of movement may need to be sensed. The biasing members may includes springs, resilient and compressible sleeves 132 (such as are shown in the drawings) or any other suitable mechanism or component, and such things may be positioned between the main housing 16 or fasteners 128 and any component movable relative thereto (e.g. the second clamp plate 48 or coil housing 54) to cause the desired return rotation to the home position. Further, in implementations with a gear ratio between the knob 12 and motor 26 as described above, relatively little movement of the knob 12 will result in greater movement of the second clamp plate 48 and coil housing 54 relative to the main housing 16 such that the movement can reliably and somewhat readily be determined by a controller 140 to facilitate subsequent action, such as releasing the brake 30. While shown diagrammatically as a separate item, the controller 140 could be contained within the housing, such as on or associated with one or more of the circuit boards 70 or 118.

When torque is applied to the knob 12 while the brake 30 is applied and rotation of certain components relative to the main housing 16 or encoder 28 is sensed, a process may be followed to determine if the brake 30 should be released or if the attempted rotation of the knob 12 should be inhibited or prevented by continued application of the brake 30. The process may be programmed into an electronic controller 140 (FIG. 4) associated with the motor 26, encoder 28 and coil 53. One example of when it may be desired to prevent rotation of the knob 12 includes attempted rotation beyond the predetermined positions of the shifter 10. For example, if there is no position counter-clockwise of PARK, then attempts to rotate the knob 12 counter-clockwise when the shifter 10 is in the position corresponding to PARK are prevented, that is, the brake 30 is not released. Likewise, if there is no position clockwise of DRIVE, then attempts to rotate the knob 12 clockwise when the shifter 10 is in the position corresponding to DRIVE are also prevented by the brake 30. The process may also take into account other vehicle conditions, for example, whether the vehicle has been started (if not, then perhaps no shifting is permitted, or perhaps only shifting to NEUTRAL), whether the vehicle is moving above forward whereupon shifting to REVERSE would be prevented by the brake 30, or whether the vehicle is moving backward whereupon shifting to DRIVE would be prevented by the brake 30, etc.

If it is determined that torque applied to the knob 12 relates to an attempted shift of the transmission that is permitted within the process, then the controller 140 may permit or cause electrical power to be supplied to the coil 53 to release the brake 30. The knob 12 may then be rotated as desired to shift the transmission and when shifting has stopped, as determined by the passage of a threshold amount of time, some detected vehicle condition or otherwise, then power to the coil 53 is terminated and the brake 30 is reapplied.

In some implementations, in addition to or instead of inhibiting knob rotation when a transmission shift is not desired or permitted, rotation of the knob 12 may be ignored by the controller 140 with which the shifter 10 is associated. Accordingly, in these situations, even if the knob 12 is rotated no transmission shift will occur, as desired. Further, physical stop surfaces may be provided to engage the knob and prevent knob rotation beyond end positions of the knob 12, for example, counter-clockwise of PARK or clockwise of DRIVE, in the example mentioned above.

Accordingly, the shifter 10 disclosed herein may be highly controllable and easily programmed for use in a wide range of vehicle applications. The number of positions to which the knob 12 may be rotated is programmable and can easily be adjusted from one application to the next. The angles through which the knob 12 needs to be rotated to change from one position to the next can be programmed/adjusted as desired and may be the same among all positions or different, as desired. The magnitude of the force applied by the motor 26 and the rate of change of the motor force may be programmed/adjusted as desired. The application or releasing of the brake 30 in any given knob position or vehicle operating condition can be programmed and controlled as desired. Further, the encoder 28 and controller 140 may enable feedback control of the transmission positions and may correct for faults or changes in the knob position relative to the transmission gear shifts to automatically account for changes and permit continued shifter operation. Secondary actions may be required to permit rotation of the knob 12 to certain positions. For example, rotation of the knob 12 to a position corresponding to REVERSE vehicle operation, or to a sport/manual shifting mode, may require that the knob 12 be axially displaced before it is rotated to provide a safeguard against accidental or unintentional shifting of the transmission to these positions. Of course, other secondary actions may be used in addition to or instead of the knob axial displacement, including actions not related to the knob or shifter. One non-limiting example includes requiring that the vehicle brake pedal be depressed a threshold amount before the shifter 10 may be moved out of the PARK position.

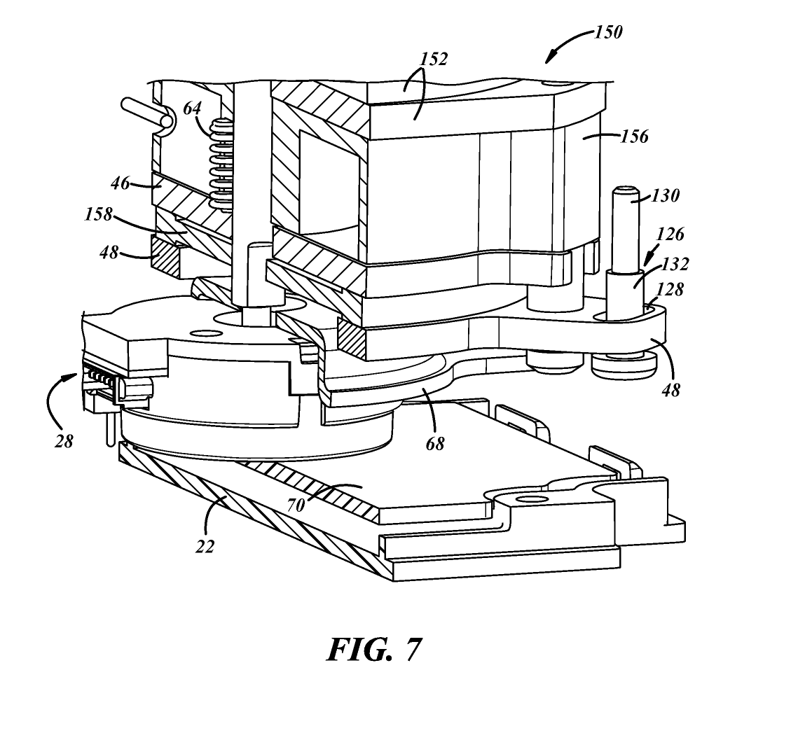

FIGS. 6 and 7 illustrate an alternate shifter 150. Most of this shifter 150 and its components and the operation/function are the same as the previous embodiment shifter 10 and the same reference numbers will be used for ease of description. Further, only the different components in shifter 150 will be highlighted.

In this implementation, the motor 152 is relatively flat (and may be a so-called “pancake motor”) and the coil 154 is located axially beneath the motor 152 rather than surrounding the motor 152. The coil housing 156 is cylindrical and this arrangement enables use of a larger coil 154 to provide a stronger magnetic field while still maintaining a relatively small overall size for the shifter 150. The springs 64 biasing the first clamp plate 46 onto the rotor 158 are located in the coil housing 156, and may be provided in pockets 160 that are located radially inwardly of the coil 154. The rotor 158 in this example is flat and has a raised or thicker annular rim 162 that is engaged directly by the first and second clamp plates 46, 48 without any pads therebetween (but of course, pads could be used). Otherwise, the shifter 150 may be constructed and function like the shifter previously described.

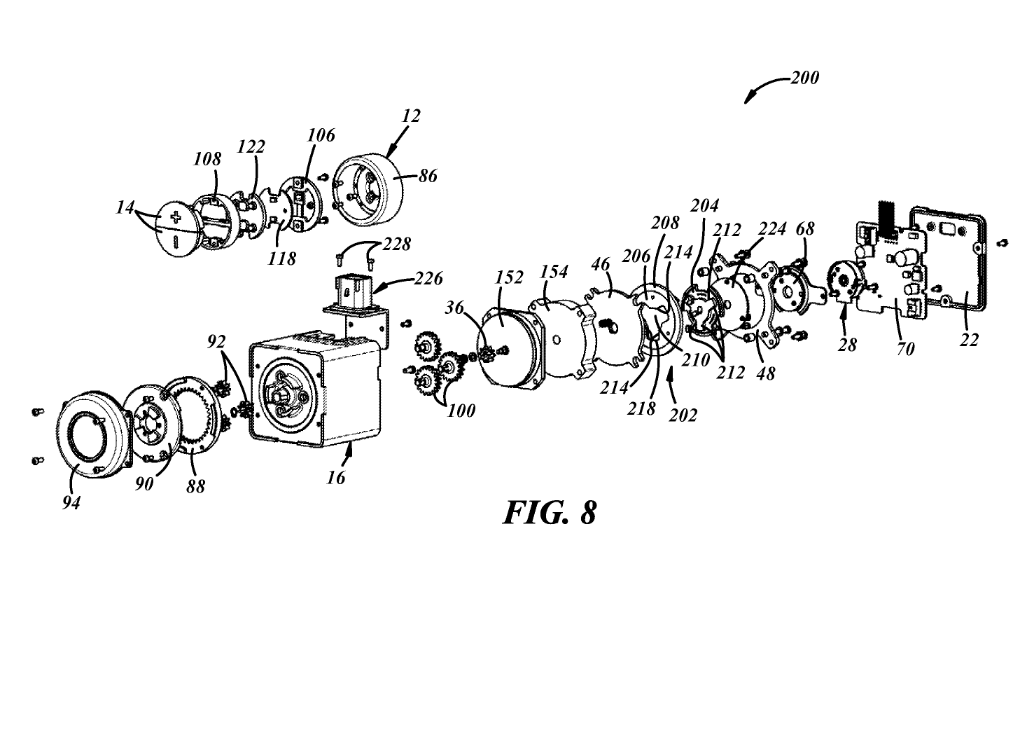

FIGS. 8-11 illustrate another implementation of a shifter 200 that provides a different lost motion coupling 202 that aids in sensing knob rotation when the brake is applied. The shifter 200 may be similar in many ways to the previously described shifters 10, 150 and to facilitate description of the shifter 200, similar reference numerals may be used to describe components that may be the same as or similar to components already described.

In this implementation of the shifter 200, the lost motion coupling 202 is provided at the brake rotor, which may be provided in more than one piece with at least some relative movement or rotation permitted between the pieces. As shown, a first rotor portion 204 is coupled to the motor shaft 34 for rotation therewith, such as by being keyed to the shaft. A second rotor portion 206 is engageable with the first rotor portion 204, in either direction of rotation of the first rotor portion and after an initial amount of rotation of the first rotor portion. In this way, limited relative movement is permitted between the first rotor portion 204 and second rotor portion 206, and the rotor portions rotate together after the limited relative movement. To provide a braking force, as described with regard to the other shifter embodiments, the second rotor portion 206 may include brake surfaces 208 on one or both sides that are engageable by the clamp discs in the same manner as described with regard to the rotor 158.

In at least one implementation, an axially compact arrangement may be provided with an annular second rotor portion 206 having a central opening 210 in which at least part of the first rotor portion 204 is received. So that the second rotor portion 206 can be driven by rotation of the first rotor portion 204, drive surfaces 212 are provided on the first rotor portion 204 and driven surfaces 214 are provided on the second rotor portion 206. The drive surfaces 212, in the implementation shown, include or are defined at least in part by one or more outwardly extending tabs 216 on the first rotor portion 204. The implementation shown uses three tabs, but other numbers including just one, may be used. The corresponding driven surfaces 214 are defined by surfaces of one or more cavities 218 in the second rotor portion 206 in which at least a portion of the tabs 216 are received. Each tab 216 may be received in a corresponding cavity 218 and each tab may engage the second rotor portion 206, within the cavity, in both directions of rotation. Therefore, each cavity 218 may include two driven surfaces 214, one on each side of the tab 216. Each cavity 218 may be wider (in the direction of rotation) than the tab 216 received therein so that the tabs may move relative to the second rotor portion 206 within the cavities.

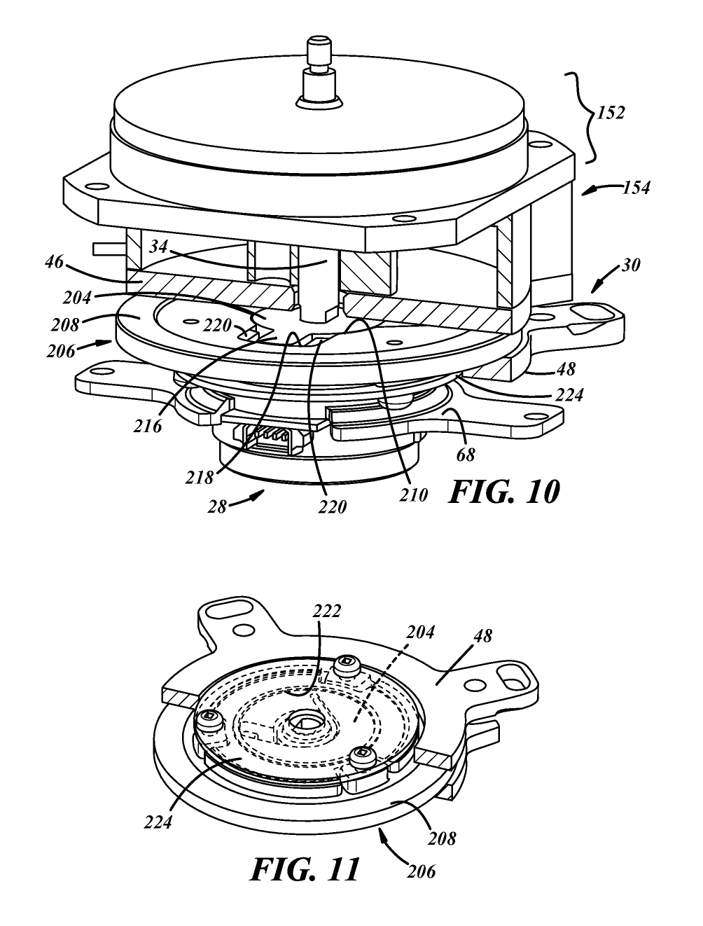

As in the prior embodiment, the knob 12 may be rotated in either direction and so it may be desirable to be able to detect rotation in either direction. To facilitate this, biasing members 220 (FIG. 10) may be provided that tend to center the tabs 216 within the cavities 218 (in the direction of rotation) so that the tabs, when centered may move in either rotational direction before causing or tending to cause movement of the second rotor portion 206. In at least some implementations, the biasing members 220 may be provided within the cavities 218, on or over at least a portion of the driven surfaces 214, and the tabs 216 may engage the biasing members upon rotation of the first rotor portion 204 relative to the second rotor portion 206. In at least some implementations, the tabs 216 might not directly engage the driven surfaces 214, but the force of the engagement with the biasing members 220 may be transmitted to the second rotor portion 206 at or through the driven surfaces 214. In this way, the biasing members 220 may also be considered to have or define the driven surfaces 214, and the biasing members may be considered to be part of the second rotor portion 206, in at least some embodiments.

Upon rotation of the first rotor portion 204 via the motor shaft 34 (for example, upon rotation of the knob), the tabs 216 rotate within the cavities 218 and this rotation is detected by the encoder 28. During this rotation, the tabs 216 engage and compress the biasing members 220 and upon doing so and during further rotation in the same direction the first rotor portion 204 is rotationally coupled to the second rotor portion 206. When the brake 30 is applied, rotation of the second rotor portion 206 is prevented (or at least substantially inhibited) which prevents rotation of the first rotor portion 204. When the brake 30 is released or not applied, the first and second rotor portions 204, 206 rotate together. When the force causing rotation of the knob 12 and first rotor portion 204 is removed, the compressed biasing members 220 expand or otherwise resiliently return to an uncompressed or less compressed state which moves the tabs 216 toward the center of their respective cavities 218, causing some relative rotation between the first and second rotor portions 204, 206. This resets the relative positions of the first and second rotor portions 204, 206 to allow for relative rotation in either direction and hence, detection of subsequent rotation in either direction as will be caused by subsequent rotation of the knob 12.

The biasing members 220 may include any resilient component that will tend to reset the relative positions of the first and second rotor portions 204, 206. Some non-limiting examples, include flexible pads of material (e.g. rubber or other elastomer) connected to the tabs 216 or to the second rotor portion 206 within the cavities 218, springs carried in pockets formed in the second rotor portion or tabs, or perhaps a torsion spring 222 arranged to store energy upon relative movement between the first and second rotor portions and to release that energy to reset the position of the tabs within the cavities as described. Of course, other biasing members may be used, and more than one type of biasing member may be used, in any desired combination.

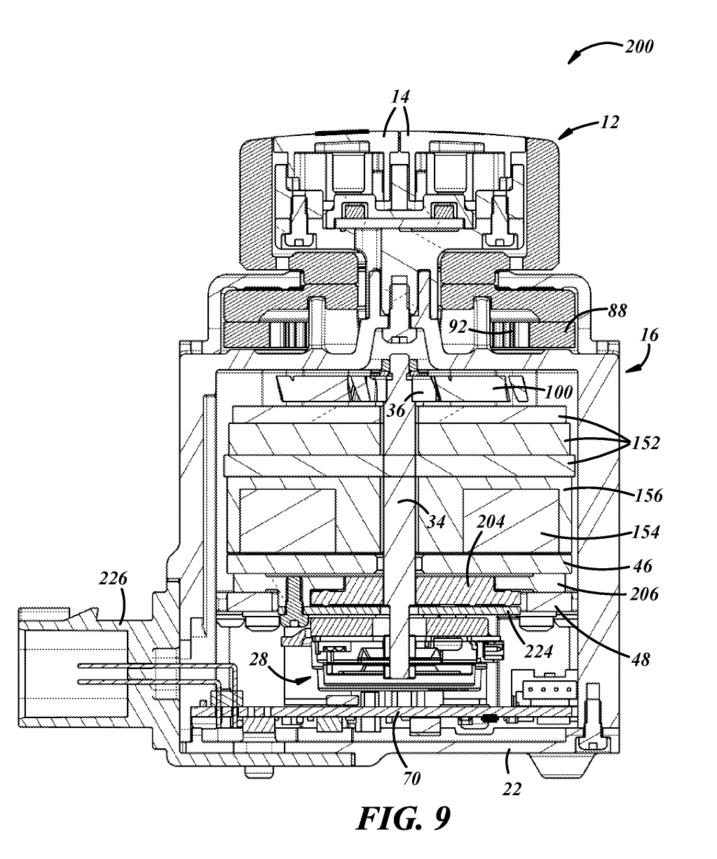

As shown in FIGS. 8-11, a cover 224 may be provided to retain the torsion spring 222, other biasing member(s) or other components. The cover 224 may be connected to the second rotor portion 206, generally overlying the first rotor portion 204 and the spring 222. In FIG. 11 the cover 224 is shown as transparent to facilitate viewing the spring 222 and first rotor portion 204 beneath the cover. An electrical connector 226 (FIGS. 8 and 9) may be provided to facilitate electrical coupling of the shifter to a vehicle control or power assembly. The connector 226 may be releasable mounted to the housing 16 such as by fasteners 228, if desired, and the shifter 200 may be configured so that the connector may be oriented in more than one position to increase the flexibility of the shifter 200. For example, the connector could extend from a sidewall of the housing, or from the bottom wall, making a single shifter assembly easier to install in a variety of applications.

The shifter 200 requires rotation of relatively few components to enable the encoder to sense initial rotation of the knob. This requires rotation of less mass, and when the rotation force is terminated (i.e. the knob is no longer being turned), requires resetting the position of less mass to detect subsequent rotation. Less force from the biasing members 220 is needed to reliably reset the relative positions of the first and second rotor portions 204, 206 than is needed to reset/rotate more components in the assembly. Also, in this implementation, less initial force is required to rotate the knob 12, gears 88, 92, 100, shaft 34 and first rotor portion 204 relative to the second rotor portion 204 than was required to rotate most of the shifter assembly as in the shifters 10 and 150. Further, there is less friction and other resistance to both initial rotation and resetting the relatively fewer and lower mass components that are rotated during initial knob rotation in the shifter 200. This facilitates initial rotation of the knob and detection of the rotation, and reliable resetting of the shifter for subsequent detection of knob rotation. In the shifter 200, with the motor pin being freed up from the clamped rotor for limited relative rotation, the motor can be used to reset the tabs within the cavities by rotating the inner rotor in an opposite direction. This can be done without any biasing members, or in addition to and assisting the biasing members.

As in the previously described implementations, the motor may be a stepper motor, and in at least some implementations, may be a so-called hybrid stepper motor, although variable-reluctance or permanent-magnet stepper motors may also be used. Stepper motors may be brushless and accurately driven in increments of rotation with a resolution of rotational position being a function of the size of the rotation increments. Hybrid stepper motors may, for example, include a stator constructed like that of a variable-reluctance motor and a rotor constructed like that of a permanent magnet motor. This may result in windings on the stator and one or more magnets on the rotor. Two windings are provided and each winding is provided on half of the stator poles. The stator poles and the rotor have teeth (the rotor may have 2 sets of teeth that extend around the periphery of the rotor and are axially and circumferentially offset from each other). Some stator teeth are aligned with and some stator teeth are misaligned with rotor teeth at any time so that application of current to the windings will cause a known rotation of the rotor. The resolution of the motor may depend on various factors including, but not limited to, the gaps between the teeth, where the number and size of the teeth are factors. In at least certain implementations, the stepper motor step angles (i.e. resolution) may be 0.9, 1.8 or 3.6 degrees, although other increments are possible. Smaller step angles may provide better feel but also may be more susceptible to tolerances within the shifter assembly, whereas larger step angles may accommodate tolerances but require larger rotational displacement to provide an indicate of intended rotation and/or provide lesser control over the rotation and shifter feedback forces.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention. For example, relative location or orientation terms like upper, lower, side, top, bottom, left, right or the like are directed to the orientation of components in the drawings and are not intended to limit the invention unless expressly noted as such a limitation. It is contemplated that the components may be oriented and arranged in other ways.

1. A rotary shifter for a vehicle transmission, comprising:
a selector adapted to be communicated with a vehicle transmission and rotated to multiple positions corresponding to different transmission gears;
a motor coupled to the selector to selectively alter the force required to rotate the selector among the multiple positions of the selector;
a controller coupled to the motor and responsive to rotation of the selector to control actuation of the motor at least in part as a function of the rotary orientation of the selector; and
a brake coupled to at least one of the selector or the motor to selectively inhibit or selectively prevent rotation of the selector.

2. The shifter of claim 1 wherein the brake includes a magnetic field generator, a rotor coupled to the motor, and a brake member responsive to a magnetic field generated by the magnetic field generator to selectively engage the rotor and inhibit or prevent rotation of the rotor and motor.

3. The shifter of claim 2 wherein the magnetic field generator includes an electrical coil.

4. The shifter of claim 2 wherein the brake member engages the rotor when electrical power is not supplied to the magnetic field generator and the brake member is released from the rotor when electrical power is supplied to the magnetic field generator.

5. The shifter of claim 2 wherein the controller is responsive to attempted rotation of the selector when the brake member is engaged with the rotor, and the controller determines whether to release the brake member from the rotor or to maintain the brake member engaged with the controller based on at least one of the position of the selector or a condition relating to vehicle operation at the time of the attempted rotation of the selector.

6. The shifter of claim 1 wherein the brake includes a first rotor portion coupled to the motor for rotation with the motor and a second rotor portion selectively engaged by the first rotor portion to permit limited relative rotation between the first rotor portion and the second rotor portion.

7. The shifter of claim 6 which also includes biasing members that yieldably bias the first rotor portion relative to the second rotor portion.

8. A rotary shifter, comprising:
a transmission gear selector adapted to be communicated with a vehicle transmission and rotated to multiple positions to shift among transmission gears, the transmission gear selector having a body and a recess defined by the body; and
a secondary selector received at least partially within the recess and arranged so that the secondary selector may be actuated separately from the transmission gear selector, wherein the transmission gear selector is rotatable relative to the secondary selector.

9. The shifter of claim 8 wherein the secondary selector includes a button that may be pushed independently of the rotation of the transmission gear selector to actuate a switch.

10. The shifter of claim 8 which also includes a lost motion coupling within the transmission gear selector that permits relative movement between two components.

11. The shifter of claim 10 wherein the relative movement between the two components occurs at the beginning of a gear selection.

12. The shifter of claim 8 wherein the transmission gear selector includes a rotatable knob adapted to be communicated with a vehicle transmission and rotated to multiple positions to command transmission gear shifts, and the secondary selector is carried by the knob and arranged so that the secondary selector may be actuated separately from the rotation of the knob and wherein the knob is rotatable relative to the secondary selector, and which also includes:
a motor coupled to the knob to selectively rotate the knob or to selectively alter the force required to rotate the knob among the multiple positions of the knob; and
a controller coupled to the motor and responsive to rotation of the knob to control actuation of the motor at least in part as a function of the rotary orientation of the knob.

13. The shifter of claim 12 which also includes a main housing and wherein the secondary selector is connected to the main housing so that the secondary selector does not rotate with the knob.

14. A rotary shifter, comprising:
a rotatable shift selector adapted to be communicated with a vehicle transmission and rotated to multiple positions to command transmission gear shifts;
a stepper motor coupled to the shift selector to selectively provide a force that affects rotation of the shift selector;
a controller coupled to the stepper motor and responsive to rotation of the shift selector to control actuation of the stepper motor at least in part as a function of the rotary orientation of the shift selector; and
an optical sensor associated with the shift selector to determine a rotary position of the shift selector or components associated with the shift selector.

15. The shifter of claim 14 wherein the optical sensor includes an optical encoder.

16. The shifter of claim 14 wherein the shift selector has at least one detent valley feel indicative of a drive condition of a motor vehicle, and the stepper motor resists movement of the shift selector in a position past the detent valley feel, assists movement of the shift selector prior to the detent valley feel, and provides a force tending to hold the position of the shift selector at the detent feel.

17. The electronic shifter of claim 16 further comprising a controller coupled to the stepper motor assembly, the stepper motor assembly having a coil which is powered in response to a signal from the controller, the power changing depending on the position of the shift selector.

18. The electronic shifter of claim 16 further comprising an optical movement sensor assembly electrically coupled to the controller, the optical movement sensor assembly having a signal indicative of movement of the shift selector.
